(19) United States
(12) Patent Application Publication
(10) Pub. No.: US 2005/0120227 A1
(43) Pub. Date: Jun. 2, 2005

(54) Method and system for secure filtering of users of a public transport network

(76) Inventor: Francis Weiss, Clamart (FR)

Correspondence Address: QUARLES & BRADY LLP, 411 E. WISCONSIN AVENUE, SUITE 2040, MILWAUKEE, WI, 53202-4497, US

(21) Appl. No.: 10/497,977

(22) PCT Filed: Dec. 4, 2002
(86) PCT No.: PCT/FR02/04179

(30) Foreign Application Priority Data
Dec. 6, 2001 (EP) 01403143.9
Feb. 26, 2002 (EP) 02290461.9

(51) Int. Cl. H04K 1/00; H04L 9/00

(52) U.S. Cl. 713/186; 713/152

(57) ABSTRACT

According to the process, a preparatory stage to transport for enrolling (10, 100) users is planned, to form a set of approved users (90), excluding people to be refused (75), and an initial stage of transport for the verification (250) of approved users.

The security filtering system contains a network (R1) with means (10, 100) of enrolling people, computerised means (60, 80, 90) for storing the identities of approved users, to which are connected the means of enrolling people, and at least one network (R6, R7) with means (250) of verification of approved users, connected to the said computerised means of storage.

The present invention concerns identity verification and filtering of users of public transport. It is a question of security measures, notably in air transport, whose importance no longer needs to be demonstrated. Filtering users has recently become a major concern for airlines.

The users of public transport that need to be considered here are passengers as well as flying personnel and ground control and service personnel such as cleaning, food services (catering), maintenance or freight; from now on we shall refer to this personnel using the overall term of servants.

By filtering, we mean the detection amongst actual or potential users, of dangerous individuals that have a record with security services, in particular the police, in order to deny them means of access to public transport.

In this context, there are few processes that allow the identity of users to be verified. In general, users must show an identity card, passport, and in some cases a visa, and filtering to access points is carried out “manually”, without electronic means, by air and border police wherever a border must be crossed and, generally speaking, by diverse security services.

Diverse controls can also be carried out during electronic reservations of the CRS (computer reservation systems) or GDS (global distribution systems) type, or at the time when passport or visa requests are processed.

These processes are not very effective or reliable, because false identities or false passports could be shown.

There exists, as a complement to these processes, airport control systems aiming to monitor, for example, the boarding of passengers, and in particular to detect if these passengers are trying to fraudulently “smuggle” merchandise, even firearms. These systems are essentially made up of metal detectors and X-ray machines.

But these complementary systems do not allow effective filtering of outgoing passengers, or detection of substitutions of people during boarding. Moreover they are not designed for this purpose.

There are, furthermore, computerised means for checking identity through fingerprints, available to police departments and in particular to INTERPOL.

These systems, called AFIS (automated fingerprint identification systems), are very laborious to implement, have a use that is specific to police activities and have very restricted access.

Needs concerning access security to public buildings have furthermore solicited the development of methods that identify or authenticate people by their biometric characteristics, for example recognition of facial shape characteristics, shape of the iris and of the eye, geometry of the hand, pitch of the voice and especially fingerprints.

In the field of electronic payments, finally, we know the very widespread use of bankcards, especially memory cards which authenticate the bearer by using a secret code during a transaction.

Thus the claimant has realised that with the means that are currently used in the fields of reservation and electronic payment, combined with the means implemented in the AFIS, it could greatly improve security in the field of public transport.

And it is to this effect that it is proposing its invention.

To this aim, the present invention concerns firstly a user security filtering process of at least one public transport network, characterised by the fact that it contains a preparatory stage to transport, that of enrolling users, in order to form at least one set of approved users, excluding the people to be refused access, and an initial transport stage, for verifying approved users.

We will here emphasise once again that servant personnel also make use to a certain extent of the transport networks and that, for these servants, the initial transport stage is an initial access stage on board the plane, train or boat, for example.

By enrolment, we mean the local enrolment, on media, for example a badge or a memory or chip card, or central enrolment, in a database, of the biometry of a person, preferably in this case his fingerprints.

By verification, we mean either what the professional calls identification, or what he calls authentication. Authentication aims to compare the freshly taken biometric print of a person with a single reference print, for example that recorded on a badge. It is a question of verification properly speaking, of a 1 to 1 comparison that can take place locally. If a personal “identification” code (PIN) is used to look up the print in a central file, the resources of a computer network must be utilised. As for the identification of a person, it is a question of comparing a print with all the prints in a central database in order to look up the identity of the person; a 1 to N comparison, with systematic use of a computer network.

For servants, one will also be able to verify the conformity of a request for boarding access in relation to a service that has been scheduled in advance.

The advantage of the process of the invention is not only to ensure that only persons that do not present a risk for the security of all transported people are accepted for transport, but also that those people that actually gain access to the means of transport really are those that were approved beforehand.

The proposed filtering makes it possible to refuse not only those people that police department(s) are looking for—there can be several black lists for the same trip, that of Interpol, that of the departure country and that of the arrival country—but it also makes it possible for transport companies to refuse access to their means of transport to individuals judged as undesirable (trouble shooters/air rage in air transport, but the problem is also encountered of course on the ground, for example aboard buses of certain localities).

The enrolment stage can be carried out at a very early stage, for example at the time the ticket is ordered or when the reservation is made, even when a visa or passport is requested or, for servants, when they are assigned to a service; this stage includes an identification phase.

In this way, the authorities and other administrations that are in charge of files of undesirable people are solicited at the earliest possible moment.

Preferably, after a preparatory stage to transport, lookup in a central file and reception of an approval notice, a transport ticket is printed containing the characteristics of the captured fingerprints.

Also preferably, after the enrolment stage for servants, lookup in a central file and reception of an approval notice, a service memory or chip card is created or updated, containing the characteristics of the captured fingerprints.

Opportunely, in the initial verification stage, the user's fingerprints are captured and they are compared with prints recorded on tickets, boarding cards or service or approval cards (authentication) or with prints stored in a central database (identification).

Equally opportunely, in the servant verification stage, updating service cards includes the recording of fingerprints and a secret code that may be compared with either a print capture or data entry of a secret code.

Attempts to substitute people are therefore really detected.

Still opportunely, in the servant verification stage, the service card that includes data making it possible to obtain the servant's service in a database where transport and services are programmed, coherence is ensured between the use of the service card by the servant to gain access to a protected zone or area, and the scheduling of the service that he must perform in the said protected zone.

Preferably, the coherence that is ensured bears on the protected zone and the time of service.

In this way, personnel from different services that are called upon to penetrate into identical protected zones can be differentiated.

The invention also concerns a user security filtering system of at least one public transport network, characterised by the fact that it contains
a network with the means to enrol people, to form at least one set of approved users,
computerised means of storing approved users' identities, to which are connected the means of enrolling people, and at least
one network with the means of verifying approved users, connected to the said computerised means of storage.

Preferably, the system includes at least one network of enrolment consoles and verification and enrolment consoles, and at least one network of verification consoles and the enrolment and verification consoles are connected to an AFIS centre and to a computerised approval server handling at least one database for storing identities of approved users.

Advantageously, each enrolment console contains, around a processor to which it is connected, a fingerprint capturing device, a keyboard for identity data entry, a printer, a memory card reader/writer and an input/output connecting interface with the other elements of the system, and each verification console includes at least one fingerprint capture device, a memory or chip card reader, a boarding card reader and a device for comparing fingerprints connected to the capture device and to the two readers.

Equally advantageously, the verification consoles that are on-board means of transport also include means of connection with a centralised system for preparing missions, and a system for managing human resources.

The invention will be better-understood using following description of the security filtering process and system, in reference to the annexed drawing, on which

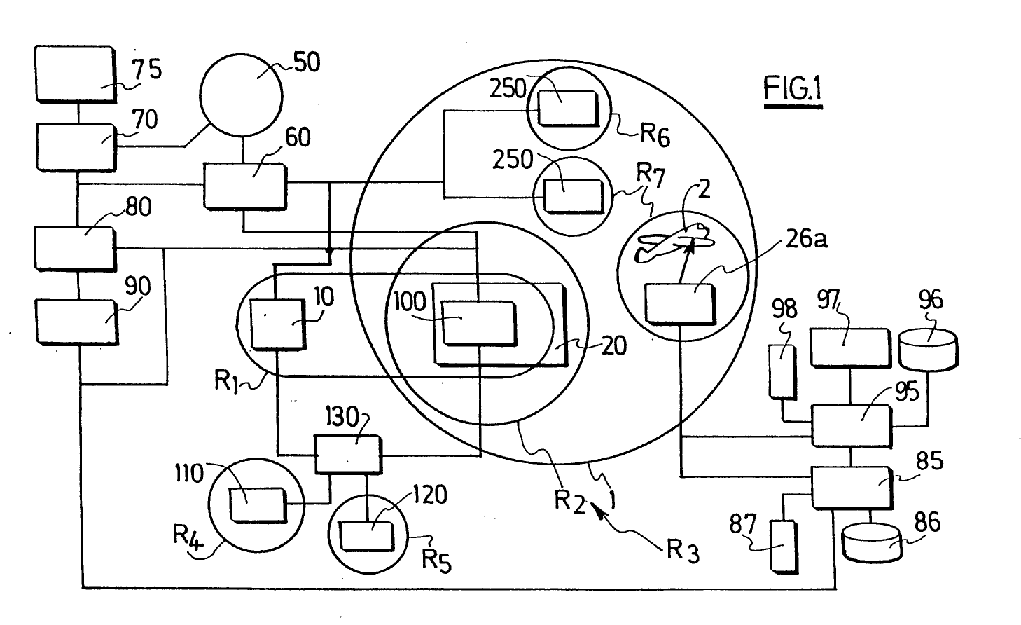

FIG. 1 is a schematic diagram and by functional units of the system;

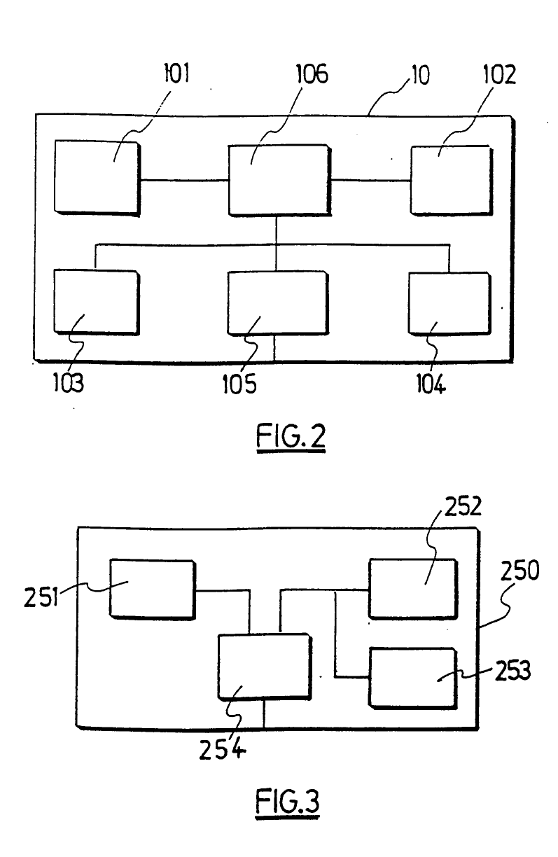

FIG. 2 is a schematic representation of an enrolment console in the system in FIG. 1;

FIG. 3 is a schematic representation of a passenger verification console of the system in FIG. 1;

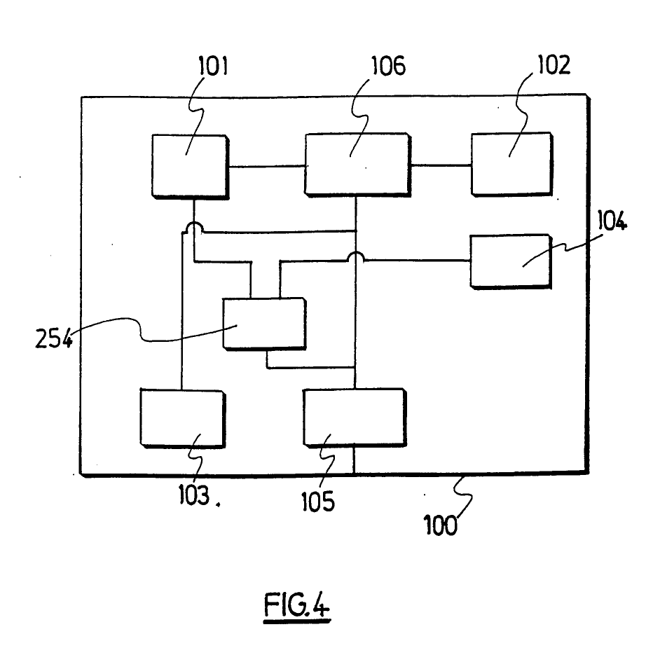

FIG. 4 is a schematic representation of an enrolment and verification console of the system in FIG. 1;

FIG. 5 is a schematic representation of a servant verification console of the system in FIG. 1 and

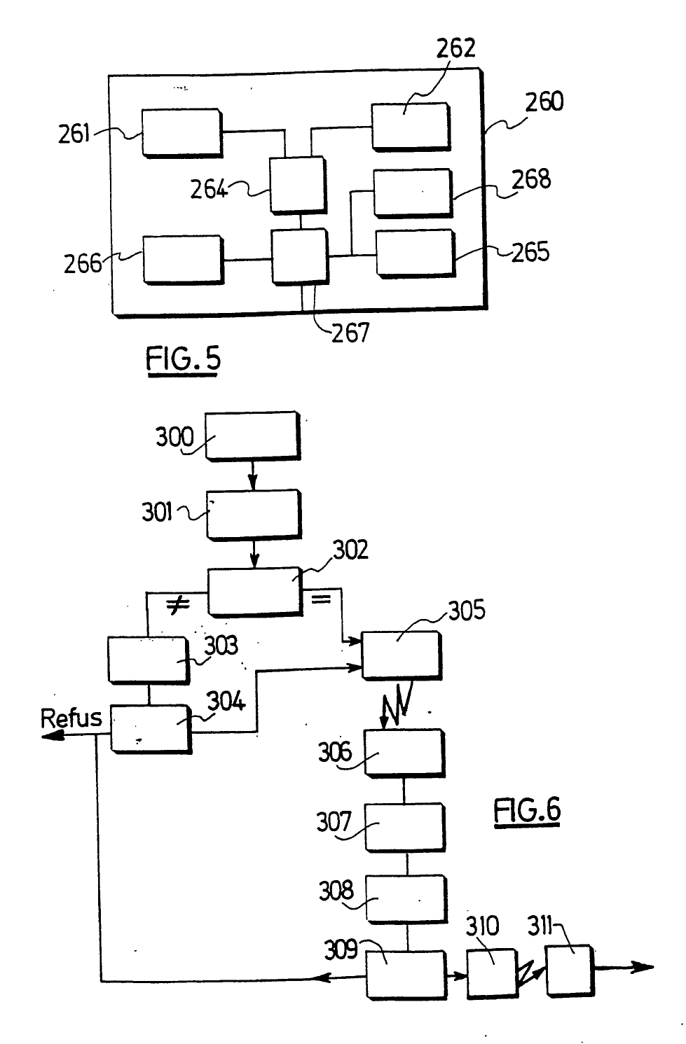

FIG. 6 is a schematic illustration by functional units of a verification of approved servants.

The system of the invention which is now going to be described, in reference to FIG. 1, is based essentially on a network R1 of people enrolment consoles, of two types: for passengers of the simplified type 10 and an elaborate type 100, in which enrolment is coupled with a verification function of people. For servants, we have planned for consoles 87 of the elaborate type seen above, but linked to one (or several) server(s) 85 for managing human resources, servers available to airlines and airport services, to handle databases 86 of servant personnel, containing in particular the references of the servants and the references of the services to which they are assigned. Enrolment consoles 10 are set up “in town”. Verification and enrolment consoles 100 are set up, either at check-in counters 20 of a network R2 of airport area airline check-in counters, as with zone 1 under consideration here, to take the example of a network R3 of air transport, or with servers 85 of human resource management.

The system also contains, in town, a network R4 of travel agencies 110 and a network R5 of airline reservation and ticket booking offices 120.

Enrolment consoles 10, 100, travel agencies 110 and the airline booking offices 120 are connected to an electronic reservations server 130 of the CRS or GDS type. Servers 85 for human resources management are, for their part, directly connected to mission preparation servers 95. The purpose of these mission preparation servers 95 is to schedule flights and airport services. They handle mission databases 96 containing in particular the references of the services to be carried out, the areas and periods involved. Beyond check-in counters 20 and the associated departure control system DCS, it is planned, in airport zone 1, a network R6 of people verification consoles 250 at boarding points (gangways and airport buses) and another network R7 of verification consoles 250 to access points on-board the plane, without forgetting the points of passage at immigration check-points. At the entrance to pilot areas, or other protected zones in the plane, verification consoles 260 for servant access are also planned. Enrolment consoles 10, 100 are connected to an AFIS centre 60 as well as to a computerised approval server 80 handling a database 90 for storing identities of approved users. Verification consoles 250 are also connected to approval server 80. Likewise, servers 85 for human resource management are connected to AFIS centre 60, to database 90 for storage of approved user identities and to verification consoles 260.

Generally speaking, we can proceed with identifying people when passports and visas are delivered, during check-in and controls during immigration, hiring or assignment to services for servant personnel, with authentication being sufficient at other points and at sales and reservations windows, boarding and disembarking, baggage delivery, etc.

The AFIS centre 60 is connected to a server 70 handling a file 75 of non-approved people that is compiled and updated by security services 50, such as INTERPOL.

All of the connections mentioned above, and the others, are provided through computerised data transmission buses and links, with the result that all the invention's system equipment is interconnected, but in a secure manner.

The enrolment that is proposed here is a recording of the biometric characteristics of people, in this case their fingerprints. In this way, database 90 and file 75 are storage elements for fingerprints of people that are respectively approved and undesirable.

In reference to FIG. 2, each enrolment console 10 contains, centralised by a processor 106 to which are connected a fingerprint capture device 101, a keyboard 102 for data entry of identity, a printer 103, a memory or chip card reader/writer 104 and an input/output connection interface 105 with the other elements in the system.

In reference to FIG. 3, each verification console 250, or security station, of networks R5 and R6 contains only a fingerprint capture device 251, a memory or chip card reader 252, a boarding card reader 253 and a fingerprint comparing device 254, connected to the capture device and to the two readers.

Each verification and enrolment console 100, in reference to FIG. 4, thus integrates the components of an enrolment console 10 and the components of a verification console 250, except for the boarding card reader 253, connected in the same way.

In reference to FIG. 5, verification consoles 260 for servants for access to the pilot's cabin are consoles of the verification console 250 type including, in addition to the corresponding elements, fingerprint capture device 261, chip card reader 262, fingerprint comparing device 264, an alpha-numeric data entry keyboard 265. The introduction of secret access codes, a radio transceiver 266, connected with a central radio transceiver 98 connected to server 95 for mission preparation, and an access approval module 267 which makes it possible or not to open the pilot's cabin according to the verifications carried out. A screen 268 completes the device to display instructions for using the console.

The fingerprint data and secret code data, if any, are written into the memories of the memory or chip cards as well as on the magnetic strip of boarding cards.

Enrolling a user consists in capturing his fingerprints, in the assigning of a secret code if any, looking up these fingerprints in database 75 containing the references and prints of undesirable individuals.

People that often use transport network R3 can have their data recorded, if they are passengers, or can be recorded, if they are servants, into database 90 of approved people. For passengers, this operation is performed with an enrolment console 10 installed in town, for example in a travel agency 110 or with an airline booking office 120, even an airport check-in counter 20, and they can obtain an approval card, which is a memory card for an approved passenger. For servants, it is at the time of hiring or on new assignments to services that require it, that recording in database 90 is carried out using console 87 of server 85, at the same time that it is done in database 86 of servant personnel.

Let us take a look now at the description of user filtering and identification stages.

For more clarity, let us first consider the case of passengers.

Before going to airport 1 to board his plane 2, a person must obtain his ticket taken from an agency 110 or at an airline booking office 120.

Before the ticket is delivered, and if the person has not had his data recorded beforehand into database 90, a prior enrolment stage takes place using elements 10, 60, 70, 75 of the system, in order to identify the passenger and ensure that he is not undesirable.

In this way, undesirable people are detected at once.

When the passenger, with his ticket, arrives at the airport, he must carry out certain ordinary formalities in order to board the plane.

During these formalities, he is asked to submit to verification procedures of his identity.

The verification consists of a verification console 250 or of a verification and enrolment console 100, and in capturing the passenger's prints and a comparison of these prints with the prints recorded, in one way or another, on the ticket or his approval card or with the prints in the central database 75.

In this way, attempts to substitute people in the airport are perfectly detected.

More precisely, when a person goes either to a travel agency 110 or to an airline booking office 120 in order to reserve or purchase a ticket, two cases are possible:
the person is in the situation of a new passenger, who has not yet been approved,
the person is in the situation of a regular passenger who has already been enrolled as such and who is approved; he has an approval card.
   Person Not Yet Approved

Agency 110 or booking office 120 records the request for a ticket thanks to a keyboard 102 and captures the fingerprints of the person thanks to capture devise 101 of console 10.

Using the data thus recorded, console 10 sends, using its interface 105, an identification request to AFIS centre 60, accompanied with the print data.

The AFIS centre then proceeds with looking up the transmitted prints in central file 75 containing the fingerprints of people that have a record with security services 50.

If the research is positive, i.e. if the prints recorded by console 10 are found in file 75, the individual is undesirable and cannot be admitted as a passenger. He is refused and the agency or booking office as well as the police are informed.

If the research is negative, console 10 receives an approval notice and prints (103) a transport ticket containing the print-out of the captured fingerprints on the back, for example in the form of a 2D barcode, which may be encrypted.

In order to avoid repeating this lookup at a later date for the same person, console 10 can provoke a memorisation of the result of this search in database 90 containing the identities of approved passengers, by the intermediary of server 80 handling database 90 and produces, with reader/writer 104 an electronic approved passenger card containing the references and prints of the passenger. This card can be used later with any verification and/or enrolment console.

Note that database 90 can moreover be updated by the AFIS services and/or police departments.

Person is Approved and Recorded in the Database

The person already has his approval card, acquired as mentioned above.

He shows it at agency 110 or booking office 120. The card is read in the electronic card reader/writer 104 in console 10. Processor 106 checks if the status of the person has not been modified by carrying out, using the input/output interface 105, a lookup request to server 80 of database 90.

In the case of a positive response, since the status has not changed, the ticket is produced as in the previous case.

In the opposite case, the person is refused.

Note that the lookup carried out here is much simpler and faster, since an alphabetic lookup in an alphanumeric file is sufficient.

With his ticket, the passenger can go to check-in counter 20 where security filtering will start with a verification procedure.

The verification of the person to be transported takes place in the following manner:
the fingerprints of the person are captured on capture device 251 on consoles 250, the fingerprints recorded on the ticket and/or approval card are read using reader 252 or 253,
the results are compared using comparison device 254 (one-to-one comparison).

The comparison device indicates if the prints read from capture device 251 are the same as those that are read on readers 252, 253. In the affirmative, the person is the bona fide one and he is invited to pass on through the security filtering station.

Concerning transport service servants now, the stages remain the same.

When he is hired for a service 5, a servant A is assigned a service chip card by his personnel department, for example the airline, who enrols him in its database 86 of servant personnel using the human resources management server 85. In parallel, the person is recorded beforehand in database 90, a prior enrolment stage is carried out using elements 60, 70, 75 of the system, to identify the servant and to ensure that he is not undesirable.

When servant A, with his service card, arrives to perform his service S, he must, in order to board the plane, and in particular in order to penetrate into protected area L, for example the cockpit, use verification console 260 and in this way undergo verification procedures of his identity.

Verification consists first of capturing servant A's prints and a comparison of his prints with the prints recorded on his service card, which makes it possible to detect any substitution of servants.

Verification is then completed by looking up in database 86 of service S′ that servant A must carry out to check the identity of services S and S′ by looking up in database 96 if service S or S′ is scheduled for protected area L and, if this is the case, a final verification can be performed, consisting in the comparison of date and time H for the scheduling of service S in zone L with the date and time when the service card is read.

These verifications are performed in real time by console 260, for the verification of identity, and by this same console 260 in connection with mission preparation server 95 and human resources management server 85.

More precisely, when the servant is hired, server 85 records the assignment request thanks to the console 87 keyboard and captures the prints of the person thanks to fingerprint capture device on console 87.

Using the data thus recorded, server 85 sends an identification request to AFIS centre 60, along with the print data.

The AFIS centre then proceeds with looking up the prints sent in central file 75 containing the prints of individuals that have a record with security services 50.

If the search is positive, i.e. if the prints enrolled by server 85 are found in file 75, the individual is undesirable and cannot be admitted as a servant. He is refused and the police are informed.

If the search is negative, server 85 receives an approval notice and produces a service card containing the characteristics of the captured prints, which may be encrypted.

This card can be used later with any other verification console.

In order to avoid repeating this lookup at a later date for the same person, server 85 can provoke a memorisation of the result of this search in database 90 containing the identities of servants using server 80 handling database 90.

Since database 90 is updated by police departments, it can therefore be periodically consulted by server 85.

Subsequently, in reference to FIGS. 5 and 6, when a service S is taken up in a protected zone or area L, servant A is called, during a first stage 300, to insert his service card into card reader 262 of verification console 260 of zone L.

Console 260 records the time and date H of the operation and then requires him in the following stage 301 to place his fingerprint or fingerprints on print reader 261. This reading gives rise, in stage 302, to a comparison using comparison device 264, for servant authentication and identification.

If this stage is not accomplished, the introduction of a secret code is required by authorisation module 267 at a second stage 303 of authentication.

In the case of authentication in the following stage 304 or as early as stage 302, authorisation module 267, at stage 305, requests that transmitter 266 send a radio authorisation access request to mission preparation server 95, and by using its transceiver 98, which, at identification stage 306 of servant A and of his assignment to service S using server 85 in its database 86, at stage 307 of recognition of protected zone L which is requesting authorisation access, and at stage 308 for verification of access time H using clock 97, determines mission A, S, L, H and checks at stage 309 the expediency for it to be executed in database 96.

If at stage 309 this verification is positive, server 95, using its transceiver 98, sends at stage 310 an access authorisation message to console 260 using its transceiver 266, which provokes the releasing, via authorisation function 267, of the access door to protected zone L.

Of course, other applications are possible. It can be arranged for example that each transport be prepared in advance and that preparation data of the A, S, H, L type be loaded before each service for each protected zone L in their verification console 260. This console then additionally contains service preparation memory updated periodically using mission preparation servers such as those that exist for military air missions.

It can also be arranged for several levels of access, with temporary or geographical restrictions that are more or less extensive according to the services being considered.

Note that authentication may also consist in comparing a freshly taken print of a person to a print in a file using a “personal identification code” (calculated PIN code).

Naturally, the system that has just been described can be extended to include the network of embassies and any other network of administrations requiring the information, these networks, as those previously described, being connected to AFIS centre 60, and so in this way to the elements to which the latter is also connected.

It will have been noted that the process of the invention that has just been described applies equally to international flights as to domestic flights. In the same way, the example considered above concerns air transport. But the invention also obviously applies to rail transport and, in general, to all other forms of transport on land and at sea.

It may also be noted that copies of the black list of file 75 could be sent to certain enrolment or verification consoles, at least to check-in counters.

Finally, it is perfectly feasible to use the elements of the system that has just been described in reference to the boarding of users of air transport also for their disembarkation, when their flights arrive.

1. Process for security filtering of users of at least one public transport network (R3), characterised by the fact that it contains an enrolment and checking stage preparatory to transport (10, 100) of users to form at least one set of approved users (90), excluding persons to be refused approval (75), and an initial stage for transport, of ID verification (250, 260) of approved users allowing them to pass through the protected access of the transport network.

2. Process according to claim 1, in which, in the preparatory enrolment stage, users are enrolled in the set of approved users (90) on enrolment consoles (10, 87) in order to receive a service or approved card.

3. Process according to claim 2, in which, after the preparatory stage to transport, look up in a central file (75) and the reception of an approval notice, a transport ticket is printed (103) containing characteristics of captured fingerprints (101).

4. Process according to claim 1, in which, before issuing a transport ticket for an approved passenger, a check is made (106, 105, 80, 90) to see if his status has not been modified.

5. Process according to claim 1, in which, in the initial verification phase, fingerprints of passengers are captured (251) and they are compared (254) with prints recorded on tickets, boarding cards or approval cards or with prints stored in a central database (75).

6. Process according to claim 2, in which, after the enrolment stage for servants, a look-up in the central file and the reception of an approval notice, a service memory or chip card is created or updated containing the characteristics of the captured fingerprints.

7. Process according to claim 6, in which, during a verification stage for access to zone (L), the fingerprints of servant (A) are captured (261) and compared (264) with the prints recorded in his service card.

8. Process according to claim 7, in which, during a verification stage for access to zone (L), time (H) of access is recorded and the databases (86, 96) are checked to see if a service (S) exists that is to be assured by servant (A), in zone (L), at time (H).

9. Process according to claim 5, in which the service cards also contain a secret code.

10. Process according to claim 9, in which at the verification stage, the secret code recorded in the card is compared to the code displayed by the servant.

11. System for security filtering users of at least one public transport network, characterised by the fact that it contains
one network (R1) of means (10, 100, 87) for enrolling people, in order to form a set of approved users,
computerised means (60, 80, 85, 86, 90) for storing identities of approved users, to which are connected the means for enrolling people, and at least
one network (R6, R7) of means (250, 260) for verifying approved users, connected to the said computerised means of storage.

12. System according to claim 11, containing a network (R1) of enrolment consoles (10, 87) and verification and enrolment consoles (100) and at least one network (R6, R7) of verification consoles (250, 260).

13. System according to claim 12, in which the enrolment consoles (10) are installed in town (R4, R5).

14. System according to claim 12, in which the verification and enrolment consoles (10, 100, 250) are connected to an AFIS centre (60) and to a computerised approval server (80) handling a database (90) for storing identities of approved passengers.

15. System according to claim 11, containing a server (70) handling a file (75) of unapproved people.

16. System according to claim 12, in which each enrolment console (10) contains, centralised by a processor (106) to which they are connected, a fingerprint capture device (101) a keyboard (102) for identity data entry, a printer (103) a memory card reader/writer (104) and an input/output connection interface (105) with the other elements in the system.

17. System according to claim 12, in which each verification console (250) contains a fingerprint capture device (251), a memory card reader (252), a boarding card reader (253) and a fingerprint comparison device (254), connected to the capture device and to the two readers.

18. System according to claim 12, in which consoles (10, 100, 250) contain a black list of unapproved passengers.

19. System according to claim 11, in which the enrolment (87) and verification (260) consoles are connected to a computerised approval server (85) handling a database (86) for storing identities of approved servants and to an AFIS centre (60).

20. System according to claim 11, containing a server (95) for preparing missions.

21. System according to claim 19, in which each verification console (260) contains a fingerprint capture device (260), a chip card reader (262), a print comparison device (264), connected to the capture device and to the reader, and a keyboard (265) and a transceiver (266).
